(19) United States
(12) Patent Application Publication
(10) Pub. No.: US 2011/0243270 A1
(43) Pub. Date: Oct. 6, 2011

(54) METHOD AND APPARATUS OF SHARING SIGNAL TRANSMISSION PORT BETWEEN DIFFERENT SIGNAL PROCESSING OPERATIONS

(76) Inventors: Kuan-Kai Juan, Hsinchu County (TW); Chia-Wei Liang, Taipei County (TW); Feng-Fu Lin, Taipei (TW); Ming-Jiou Yu, Taipei City (TW); Cheng-Chung Kuo, Taichung County (TW); Shy-Junn Hsiao, Taipei City (TW)

(21) Appl. No.: 12/962,667

(22) Filed: Dec. 8, 2010

Related U.S. Application Data
(60) Provisional application No. 61/319,886, filed on Apr. 1, 2010.

(51) Int. Cl. H04L 27/04; H04B 1/38

(52) U.S. Cl. 375/295; 375/219

(57) ABSTRACT

An exemplary signal processing apparatus includes a signal transmission port, a first signal processing circuit, a second signal processing circuit, and a control circuit. The signal transmission port is shared between a first signal processing operation and a second signal processing operation. The first signal processing circuit performs the first signal processing operation, wherein when the signal processing apparatus operates, the first signal processing circuit is not required to be consistently enabled to use the signal transmission port for signal transmission. The second signal processing circuit performs the second signal processing operation, wherein the signal transmission port is not always required to carry out signal transmission each time the second signal processing circuit is enabled to perform the second signal processing operation. The control circuit selectively enables the first signal processing circuit or the second signal processing circuit.

### CROSS REFERENCE TO RELATED APPLICATIONS

This application claims the benefit of U.S. Provisional Application No. 61/319,886, filed on Apr. 1, 2010 and incorporated herein by reference.

### BACKGROUND

The disclosed embodiments of the present invention relate to outputting/receiving signals via a signal transmission port, and more particularly, to a method and apparatus of sharing a signal transmission port (e.g., a pin of a chip) between different signal processing operations.

In general, a chip has a plurality of pins used for outputting signals, receiving signals, and receiving reference voltages including a supply voltage and a ground voltage. When the chip is designed to support more functions, more pins are required. For example, each function requires at least one dedicated pin assigned thereto. Taking an optical disc drive for example, a controller chip may include a light emitting diode (LED) driving circuit, an optical disc ejection detecting circuit, and an RS232 transmitting circuit, wherein the LED driving circuit drives an external LED by outputting a driving signal via a dedicated pin which is coupled to the LED, the optical disc ejection detecting circuit detects whether an optical disc ejection event occurs by monitoring a voltage level at a dedicated pin which is coupled to an optical disc ejection switch, and the RS232 transmitting circuit generates an output to an external RS232 receiving circuit via a dedicated pin which is coupled to the RS232 receiving circuit.

Thus, there is a need for an innovative chip design which can reduce the pin count to thereby reduce the chip area and the production cost.

### SUMMARY

In accordance with exemplary embodiments of the present invention, a method and apparatus of sharing a signal transmission port (e.g., a pin of a chip) between different signal processing operations are proposed to solve the above-mentioned problem.

According to a first aspect of the present invention, an exemplary signal processing apparatus is disclosed. The exemplary signal processing apparatus includes a signal transmission port, a first signal processing circuit, a second signal processing circuit, and a control circuit. The signal transmission port is shared between different signal processing operations for signal transmission, wherein the different signal processing operations include a first signal processing operation and a second signal processing operation. The first signal processing circuit performs the first signal processing operation, wherein when the signal processing apparatus operates, the first signal processing circuit is not required to be consistently enabled to use the signal transmission port for signal transmission. The second signal processing circuit performs the second signal processing operation, wherein the signal transmission port is not always required to carry out signal transmission each time the second signal processing circuit is enabled to perform the second signal processing operation. The control circuit controls the first signal processing circuit and the second signal processing circuit, wherein the control circuit selectively enables the first signal processing circuit to perform the first signal processing operation or enables the second signal processing circuit to perform the second signal processing operation.

According to a second aspect of the present invention, an exemplary signal processing method is disclosed. The exemplary signal processing method includes the following steps: providing a signal transmission port shared between different signal processing operations for signal transmission, wherein the different signal processing operations include a first signal processing operation and a second signal processing operation; and selectively enabling the first signal processing operation or the second signal processing operation. When the signal processing method is executed, the first signal processing operation is not required to be consistently enabled to use the signal transmission port for signal transmission, and the signal transmission port is not always required to carry out signal transmission each time the second signal processing operation is enabled.

According to a third aspect of the present invention, an exemplary electronic apparatus is disclosed. The exemplary electronic apparatus includes a first circuit element, a second circuit element, and a chip. The chip includes a pin, a first signal processing circuit, a second signal processing circuit, and a control circuit. The pin is coupled to the first circuit element and the second circuit element, wherein the pin is shared between different signal processing operations for signal transmission, and the different signal processing operations include a first signal processing operation and a second signal processing operation. The first signal processing circuit performs the first signal processing operation and communicates with the first circuit element via the pin, wherein when the chip operates, the first signal processing circuit is not required to be consistently enabled to use the signal transmission port for signal transmission. The second signal processing circuit performs the second signal processing operation and communicates with the second circuit element via the pin, wherein the signal transmission port is not always required to carry out signal transmission each time the second signal processing circuit is enabled to perform the second signal processing operation. The control circuit controls the first signal processing circuit and the second signal processing circuit, wherein the control circuit selectively enables the first signal processing circuit to perform the first signal processing operation or enables the second signal processing circuit to perform the second signal processing operation.

According to a fourth aspect of the present invention, an exemplary electronic device is disclosed. The exemplary electronic device includes a transmitting circuit and a receiving circuit. The transmitting circuit has a connection node, wherein the transmitting circuit generates a transmission signal passing through the connection node. The receiving circuit has a low-voltage differential signaling (LVDS) interface with a first connection node and a second connection node, wherein the first connection node is coupled to the connection node of the transmitting circuit, and the second connection node is coupled to a reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a generalized signal processing apparatus according to an exemplary embodiment of the present invention.

FIG. 2 is a diagram illustrating a first exemplary embodiment of an electronic apparatus employing the hardware configuration shown in FIG. 1 according to the present invention.

FIG. 3 is a diagram illustrating an operation of the electronic apparatus shown in FIG. 2.

FIG. 4 is a diagram illustrating a second exemplary embodiment of an electronic apparatus employing the hardware configuration shown in FIG. 1 according to the present invention.

FIG. 5 is a diagram illustrating an operation of the electronic apparatus shown in FIG. 4.

FIG. 6 is a diagram illustrating a third exemplary embodiment of an electronic apparatus employing the hardware configuration shown in FIG. 1 according to the present invention.

FIG. 7 is a diagram illustrating a fourth exemplary embodiment of an electronic apparatus employing the hardware configuration shown in FIG. 1 according to the present invention.

FIG. 8 is a diagram illustrating a fifth exemplary embodiment of an electronic apparatus according to the present invention.

FIG. 9 is a diagram illustrating one exemplary electronic apparatus employing the hardware configuration shown in FIG. 8.

FIG. 10 is a diagram illustrating the operation of the electronic apparatus shown in FIG. 9.

FIG. 11 is a diagram illustrating another exemplary electronic apparatus employing the hardware configuration shown in FIG. 8.

FIG. 12 is a diagram illustrating the operation of the electronic apparatus shown in FIG. 11.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The conception of the present invention is to share a signal transmission port (e.g., a pin of a chip) between different signal processing operations. In this way, the pin count of a chip can be effectively reduced. In addition, the chip area and the production cost of the chip are reduced accordingly. More specifically, based on the inherent characteristics of the signal processing operations, the signal processing operations can be performed in a time-sharing manner. As a result, one signal transmission port (e.g., one pin of a chip) is sufficient to meet the signal transmission requirements of the signal processing operations. Further detail is described as follows.

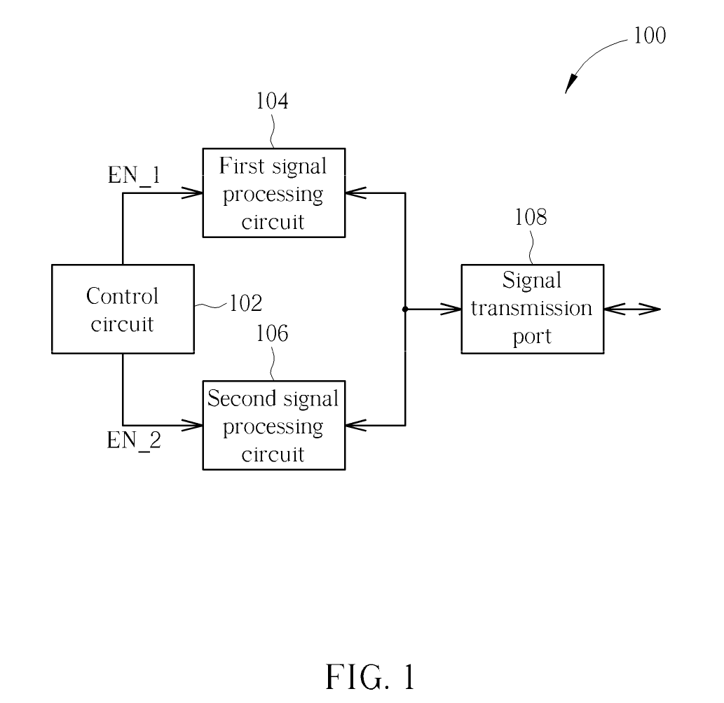

Please refer to FIG. 1, which is a diagram illustrating a generalized signal processing apparatus according to an exemplary embodiment of the present invention. The exemplary signal processing apparatus 100 includes, but is not limited to, a control circuit 102, a first signal processing circuit 104, a second signal processing circuit 106, and a signal transmission port 108. The signal transmission port 108 is shared between different signal processing operations for signal transmission. For example, the signal transmission port 108 is used to output/receive signals for one signal processing operation, and also used to output/receive signals for another signal processing operation. In this exemplary embodiment, the signal transmission port 108 is shared between a first signal processing operation that is performed by the first signal processing circuit 104 and a second signal processing operation that is performed by the second signal processing circuit 106. It should be noted that when the signal processing apparatus 100 operates, the first signal processing circuit 104 is not required to be consistently enabled to use the signal transmission port 108 for signal transmission; additionally, the signal transmission port 108 is not always required to carry out signal transmission each time the second signal processing circuit 106 is enabled to perform the second signal processing operation. Due to the above-mentioned characteristics of the first signal processing circuit 104 and the second signal processing circuit 106, the signal transmission port 108 shared between the first signal processing circuit 104 and the second signal processing circuit 106 can meet the signal transmission requirements of both of the first signal processing circuit 104 and the second signal processing circuit 106. The control circuit 102 is used for controlling the first signal processing circuit 104 and the second signal processing circuit 106. For example, the control circuit 102 selectively enables the first signal processing circuit 104 to perform the first signal processing operation by sending one control signal EN_1 or enables the second signal processing circuit 106 to perform the second signal processing operation by sending another control signal EN_2.

In one exemplary design, the first signal processing operation performed by the first signal processing circuit 104 may output an output signal via the signal transmission port 108, and/or the second signal processing operation performed by the second signal processing circuit 106 may detect an occurrence of an input signal received at the signal transmission port 108. For better understanding of technical features of the present invention, certain exemplary implementations based on the hardware configuration shown in FIG. 1 are discussed hereinafter.

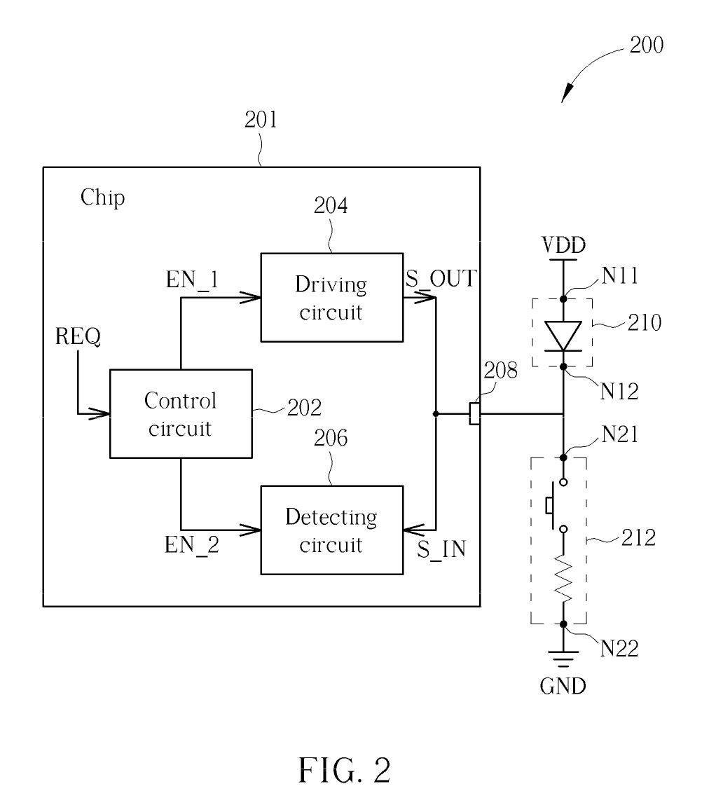

FIG. 2 is a diagram illustrating a first exemplary embodiment of an electronic apparatus according to the present invention. The exemplary electronic apparatus 200 includes, but is not limited to, a chip 201 and a plurality of circuit elements such as a light emitting device 210 and a switch device 212. The chip 201 follows the hardware configuration shown in FIG. 1, and therefore has a control circuit 202 which realizes the control circuit 102 shown in FIG. 1, a driving circuit 204 which realizes the first signal processing circuit 104 shown in FIG. 1, a detecting circuit 206 which realizes the second signal processing circuit 106 shown in FIG. 1, and a pin 208 which realizes the signal transmission port 108 shown in FIG. 1. By way of example, but not limitation, the electronic apparatus 200 may be employed in an optical disc drive, where the chip 201 may serve as a controller chip of the optical disc drive, the light emitting device 210 may serve as an indicator for informing the user of a specific working status of the optical disc drive, and the switch device 212 may serve as an optical disc ejection switch for triggering an optical disc ejection event when depressed. Thus, the driving circuit 204 is implemented to generate an output signal S_OUT utilized to drive the light emitting device 210, and the detecting circuit 206 is implemented to monitor a switch status change of the switch device 212 by detecting an occurrence of an input signal S_IN generated due to the switch status change of the switch device 212.

In a case where the light emitting device 210 serves as an indicator of the optical disc drive, the light emitting device 210 is turned on only when there is a need to inform the user of the working status of the optical disc drive. In other words, when the chip 201 operates, the driving circuit 204 is not required to be consistently enabled to use the pin 208 for outputting the output signal (e.g., a driving signal) S_OUT to the light emitting device 210. In addition, considering a case where the switch device 212 serves as an optical disc ejection switch of the optical disc drive, the input signal S_IN is presented at the pin 208 only when an optical disc ejection event is triggered by depressing the optical disc ejection switch. Thus, the pin 208 of the chip 201 is not always required to carry out signal transmission each time the detecting circuit 206 is enabled to monitor the switch status change of the switch device 212.

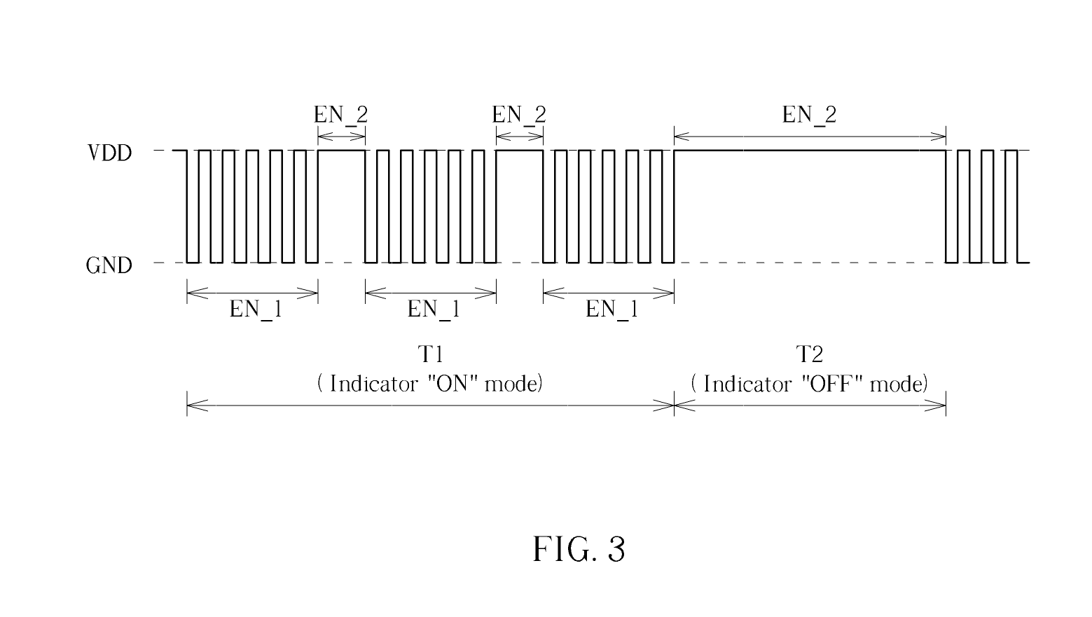

Please refer to FIG. 3 in conjunction with FIG. 2. FIG. 3 is a diagram illustrating an operation of the electronic apparatus 200 shown in FIG. 2. When the control circuit 202 receives a request REQ for the first signal processing operation (e.g., turning on the indicator), the control circuit 202 alternately enables the first signal processing circuit which is realized by the driving circuit 204 and the second signal processing circuit which is realized by the detecting circuit 206 during a first time period T1. In this embodiment, the light emitting device 210 is simply implemented using a light emitting diode (LED) with a first node (e.g., an anode) N11 coupled to a first reference voltage (e.g., a supply voltage VDD) and a second node (e.g., a cathode) N12 coupled to the pin 208, and the switch device 212 has a first node N21 coupled to the pin 208 and a second node N22 coupled to a second reference voltage (e.g., a ground voltage GND). Thus, the light emitting device 210 is turned on only when the LED is forward biased by a voltage level at the pin 208 that is lower than the first reference voltage (e.g., the supply voltage VDD). Additionally, when the switch device 212 is switched on, the switch device 212 pulls down the voltage level at the pin 208 toward the second reference voltage (e.g., the ground voltage GND) to trigger a switch status change event. In other words, the input signal S_IN having the second reference voltage (e.g., the ground voltage GND) will be generated due to the switch status change of the switch device 212. It should be noted that using an LED to realize the light emitting device 210 is for illustrative purposes only. In a practical application, any light source which is driven by the output signal S_OUT generated from the driving circuit 204 can be employed to act as the light emitting device 210.

In this exemplary embodiment, when the driving circuit 204 is enabled, it employs a pulse-width modulation (PWM) scheme to generate the output signal S_OUT used to control the brightness of the light emitting device 210, as shown in FIG. 3. In addition, when the detecting circuit 206 is enabled, it sets the voltage level at the pin 208 by the first reference voltage (e.g., the supply voltage VDD) for monitoring the switch status change of the switch device 212 by detecting if the input signal S_IN with the second reference voltage (e.g., the ground voltage GND) is received from the pin 208. For example, the detecting circuit 206 may has a controllable switch which is switched on to couple the supply voltage VDD to the pin 208 when enabled by the control signal EN_2. In other words, upon detecting that the voltage level at the pin 208 has a transition from a default voltage value to another voltage value, the detecting circuit 206 will identify the input signal S_IN generated due to the switch status change of the switch device 212.

Generally speaking, the duration of depressing the switch device 212 is about several hundreds of miniseconds. Therefore, to successfully detect any switch status change event of the switch device 212, the interval between two successive second signal processing operations (i.e., detecting the switch status change event of the switch device 212) should be shorter than the duration of depressing the switch device 212. For example, the interval between two second signal processing operations is about 20 miniseconds. In addition, the detecting circuit 206 may complete one switch status change detection operation in a short time. As the time period granted to the detecting circuit 206 for detecting the switch status change event of the switch device 212 (i.e., the interval between two successive first signal processing operations) may be short, the user may not perceive an interruption caused by the switch status change detection operation performed during the process of driving the light emitting device 210. Thus, though the control circuit 202 alternately enables the driving circuit 204 and the detecting circuit 206 during the first time period T1, the objective of turning on the light emitting device 210 to inform the user of the current working status of the optical disc drive is still achieved. In addition, though the pin 208 is shared by both of the driving circuit 204 and the detecting circuit 206 during the first time period T1, any switch status change event of the switch device 212 can be successfully detected.

Moreover, as shown in FIG. 3, when the control circuit 202 does not receive the request REQ for turning on the indicator, the control circuit 202 enables the second signal processing circuit which is realized by the detecting circuit 206 and does not enable the first signal processing circuit which is realized by the driving circuit 204 during a second time period T2. In other words, during the second time period T2, the pin 208 is dedicated to receiving the input signal S_IN generated in response to the switch status change of the switch device 212. It should be noted that when the detecting circuit 206 is initially enabled during the second time period T2, the detecting circuit 206 sets a voltage level of the pin 208 to a constant voltage level (e.g., the supply voltage VDD) for detecting the occurrence of the input signal S_IN and turning off the light emitting device 210. When the switch device 212 is switched on to trigger a switch status change event during the second time period T2, the voltage level at the pin 208 is pulled down to the ground voltage GND, thereby turning on the light emitting device 210 at the absence of the output signal S_OUT. Thus, the user is informed of the switch status change event by the indication of the light emitting device 210 though the driving circuit 204 is not enabled during the second time period T2.

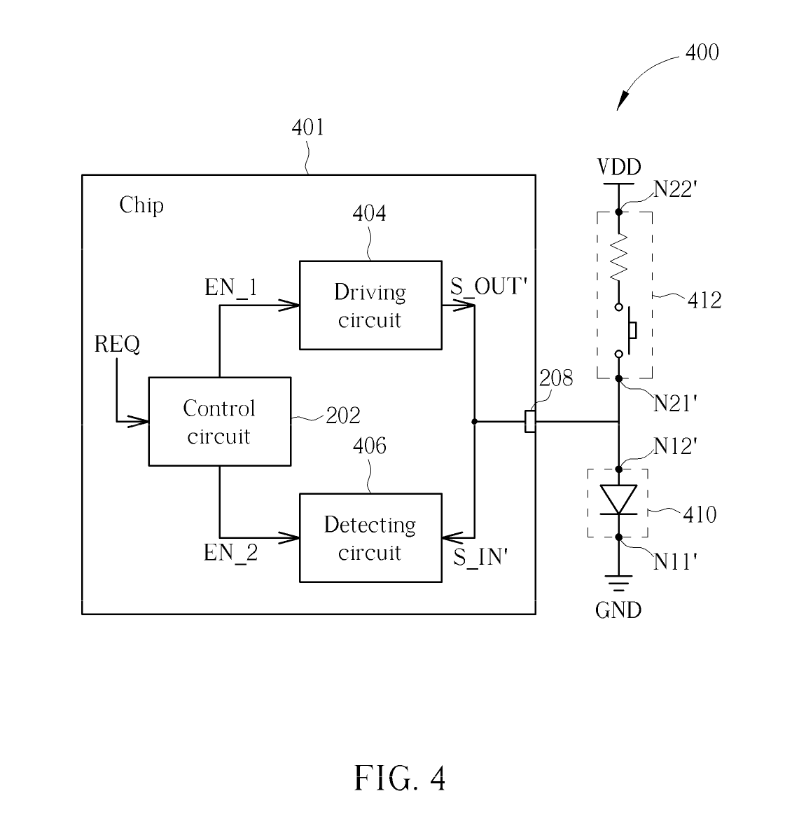

FIG. 4 is a diagram illustrating a second exemplary embodiment of an electronic apparatus according to the present invention. The exemplary electronic apparatus 400 includes, but is not limited to, a chip 401 and a plurality of circuit elements such as a light emitting device 410 and a switch device 412. Similarly, the chip 401 also follows the hardware configuration shown in FIG. 1. The major difference between the electronic apparatuses 200 and 400 is the arrangement of the light emitting device 410 and the switch device 412. In this embodiment shown in FIG. 4, the light emitting device 410 is implemented using an LED with a first node (e.g., a cathode) N11′ coupled to a first reference voltage (e.g., a ground voltage GND) and a second node (e.g., an anode) N12′ coupled to the pin 208, and the switch device 212 has a first node N21′ coupled to the pin 208 and a second node n22′ coupled to a second reference voltage (e.g., a supply voltage VDD). Thus, the light emitting device 410 is turned on only when the LED is forward biased by a voltage level at the pin 208 that is higher than the first reference voltage (e.g., the ground voltage GND); additionally, when the switch device 412 is switched on, the switch device 412 pulls up the voltage level at the pin 208 toward the second reference voltage (e.g., the supply voltage VDD) to trigger a switch status change event. In other words, the output signal S_OUT′ which sets the voltage level at the pin 208 by the first reference voltage (e.g., the ground voltage GND) turns off the light emitting device 410; on the other hand, the output signal S_OUT′ which sets the voltage level at the pin 208 by the second reference voltage (e.g., the supply voltage VDD) turns on the light emitting device 410. Moreover, the input signal S_IN′ having the second reference voltage (e.g., the supply voltage VDD) is generated due to the switch status change of the switch device 412. It should be noted that using an LED to realize the light emitting device 410 is for illustrative purposes only. In a practical application, any light source which is driven by the output signal S_OUT′ generated from the driving circuit 404 can be employed to act as the light emitting device 410.

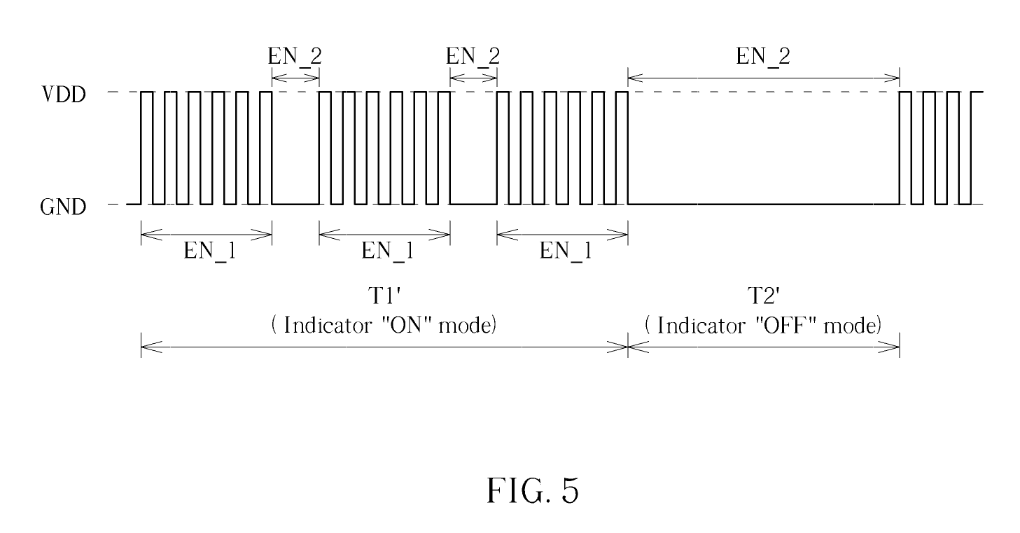

Please refer to FIG. 5 in conjunction with FIG. 4. FIG. 5 is a diagram illustrating an operation of the electronic apparatus 400 shown in FIG. 4. When the control circuit 202 receives a request REQ for the first signal processing operation (e.g., turning on the indicator), the control circuit 202 alternately enables the first signal processing circuit which is realized by the driving circuit 404 and the second signal processing circuit which is realized by the detecting circuit 406 during a first time period T1′. Similarly, when the driving circuit 404 is enabled, it employs a PWM scheme to generate the output signal S_OUT′ used to control the brightness of the light emitting device 410. In addition, when the detecting circuit 406 is enabled, it sets the voltage level at the pin 208 by the first reference voltage (e.g., the ground voltage GND) for monitoring the occurrence of the switch status change of the switch device 412 by detecting if the input signal S_IN′ with the second reference voltage (e.g., the supply voltage VDD) is received from the pin 208.

For example, the detecting circuit 406 may has a controllable switch which is switched on to couple the ground voltage VDD to the pin 208 when enabled by the control signal EN_2. To successfully detect any switch status change event of the switch device 412, the interval between two successive second signal processing operations (i.e., detecting the switch status change event of the switch device 412) should be shorter than the duration of depressing the switch device 412. Thus, though the control circuit 202 alternately enables the driving circuit 404 and the detecting circuit 406 during the first time period T1′, the objective of turning on the light emitting device 410 to inform the user of the current working status of the optical disc drive is still achieved. In addition, though the pin 208 is shared by both of the driving circuit 404 and the detecting circuit 406 during the first time period T1, any switch status change event of the switch device 412 can be successfully detected. As shown in FIG. 5, when the control circuit 202 does not receive the request REQ for the first signal processing operation, the control circuit 202 enables the second signal processing circuit (e.g., the detecting circuit 406) and does not enable the first signal processing circuit (e.g., the driving circuit 404) during a second time period T2′.

It should be noted that when the detecting circuit 406 is initially enabled during the second time period T2′, the detecting circuit 406 sets a voltage level of the pin 208 to a constant voltage level (e.g., the ground voltage GND) for detecting the occurrence of the input signal S_IN and turning off the light emitting device 410. When the switch device 412 is switched on to trigger a switch status change event during the second time period T2′, the voltage level at the pin 208 is pulled up to the supply voltage VDD, thereby turning on the light emitting device 410 at the absence of the output signal S_OUT. Thus, the user is still informed of the switch status change event by the indication of the light emitting device 410 though the driving circuit 404 is not enabled during the second time period T2′.

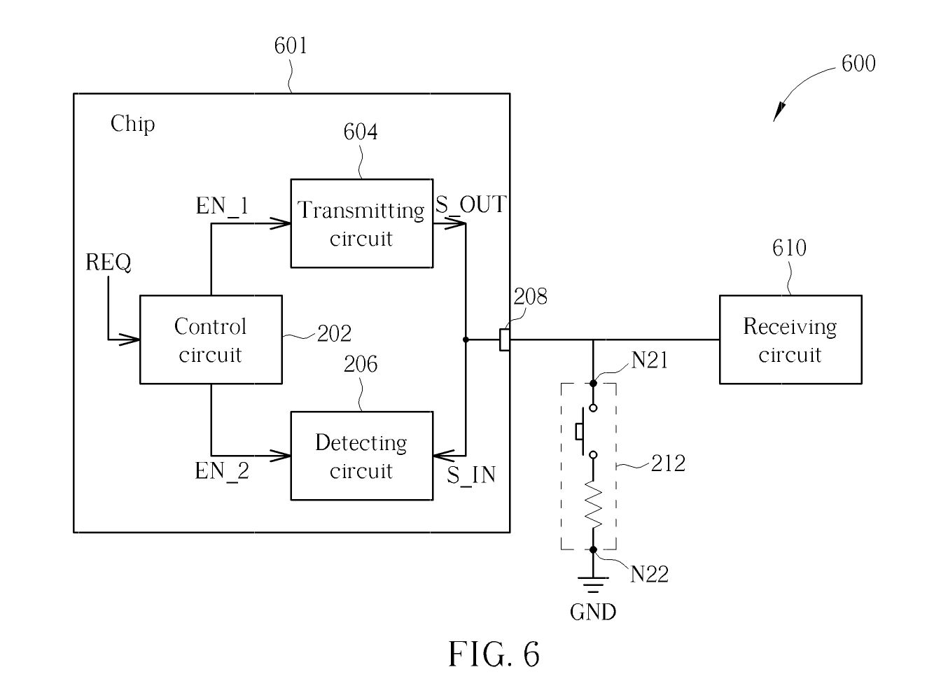

FIG. 6 is a diagram illustrating a third exemplary embodiment of an electronic apparatus according to the present invention. The exemplary electronic apparatus 600 includes, but is not limited to, a chip 601 and a plurality of circuit elements such as a receiving circuit 610 and the aforementioned switch device 212. The chip 601 also follows the hardware configuration shown in FIG. 1, and therefore has the aforementioned control circuit 202 which realizes the control circuit 102 shown in FIG. 1, a transmitting circuit 604 which realizes the first signal processing circuit 104 shown in FIG. 1, the aforementioned detecting circuit 206 which realizes the second signal processing circuit 106 shown in FIG. 1, and the aforementioned pin 208 which realizes the signal transmission port 108 shown in FIG. 1. The major difference between the electronic apparatuses 200 and 600 is that the driving circuit 204 used for driving the light emitting device 210 is replaced by the transmitting circuit 604, such as an RS232 transmitter, used for transmitting an output signal S_OUT to the receiving circuit 610 such as an RS232 receiver. When the chip (e.g., a control chip of an optical disc drive) 601 operates, the transmitting circuit 604 is not required to be consistently enabled to use the pin 208 for outputting the output signal (e.g., a data signal) S_OUT to the receiving circuit 610. That is, the transmitting circuit 604 is enabled only when there is data to be transmitted to the receiving circuit 610. By way of example, but not limitation, the transmitting circuit 604 and the receiving circuit 610 are particularly used under a debug mode, and the output data S_OUT carries debug information.

When the control circuit 202 receives a request REQ for the first signal processing operation (e.g., transmitting data to the receiving circuit 610), the control circuit 202 alternately enables the first signal processing circuit (e.g., the transmitting circuit 604) and the second signal processing circuit (e.g., the detecting circuit 206) during a first time period (e.g., the first time period T1 shown in FIG. 3). As shown in FIG. 6, the switch device 212 has the first node N21 coupled to the pin 208 and the second node N22 coupled to a reference voltage (e.g., a ground voltage GND). Thus, the switch device 212 pulls down the voltage level at the pin 208 toward the reference voltage (e.g., the ground voltage GND) to trigger a switch status change event when the switch device 212 is switched on. In other words, the input signal S_IN having the reference voltage (e.g., the ground voltage GND) is generated due to the switch status change of the switch device 212. When the control circuit 202 does not receive the request REQ for the first signal processing operation, the control circuit 202 enables the second signal processing circuit (e.g., the detecting circuit 206) and does not enable the first signal processing circuit (e.g., the transmitting circuit 604) during a second time period (e.g., the second time period T2 shown in FIG. 3). As the major difference between the electronic apparatuses 200 and 600 is the first signal processing operation performed by the electronic apparatus 600 for transmitting the output signal S_OUT to the receiving circuit 610, a person skilled in the art can readily understand the operation of the electronic apparatus 600 after reading above paragraphs directed to FIG. 2 and FIG. 3. Further description is therefore omitted here for brevity.

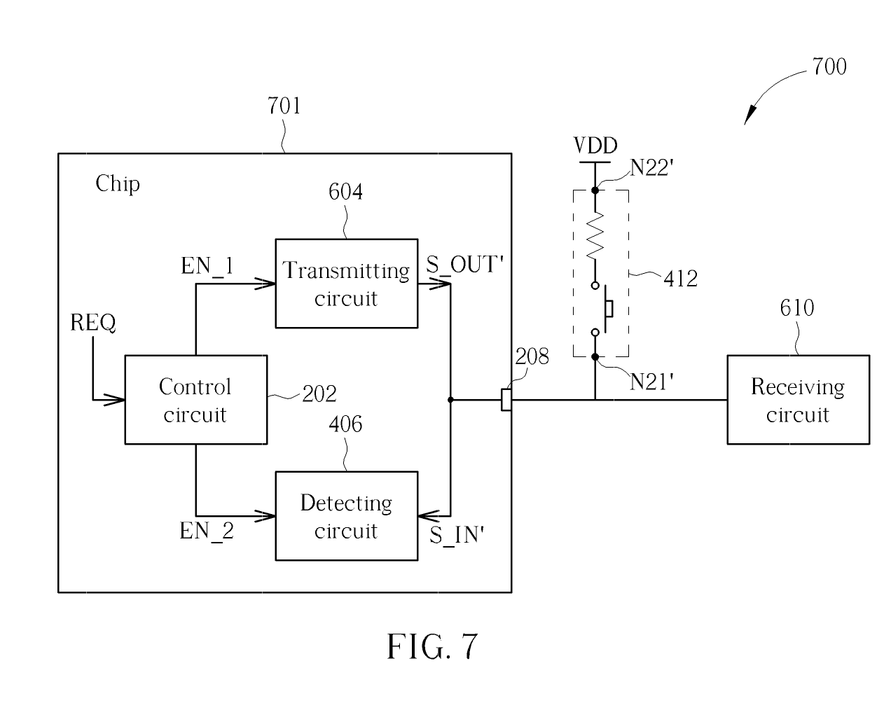

FIG. 7 is a diagram illustrating a fourth exemplary embodiment of an electronic apparatus according to the present invention. The exemplary electronic apparatus 700 includes, but is not limited to, a chip 701 and a plurality of circuit elements such as the aforementioned receiving circuit 610 and switch device 412. The chip 701 also follows the hardware configuration shown in FIG. 1. The difference between the electronic apparatuses 600 and 700 is the arrangement of the switch device. In this embodiment shown in FIG. 7, the switch device 412 has the first node N21′ coupled to the pin 208 and the second node N22′ coupled to a reference voltage (e.g., a supply voltage VDD). Thus, the switch device 412 pulls up the voltage level at the pin 208 toward the reference voltage (e.g., the supply voltage VDD) to trigger a switch status change event when the switch device 412 is switched on. In other words, the input signal S_IN′ having the reference voltage (e.g., the supply voltage VDD) is generated due to the switch status change of the switch device 412. As the major difference between the electronic apparatuses 400 and 700 is that the first signal processing operation performed by the electronic apparatus 700 is to transmit the output signal S_OUT′ to the receiving circuit 610, a person skilled in the art can readily understand the operation of the electronic apparatus 700 after reading above paragraphs directed to FIG. 4 and FIG. 5. Further description is therefore omitted here for brevity.

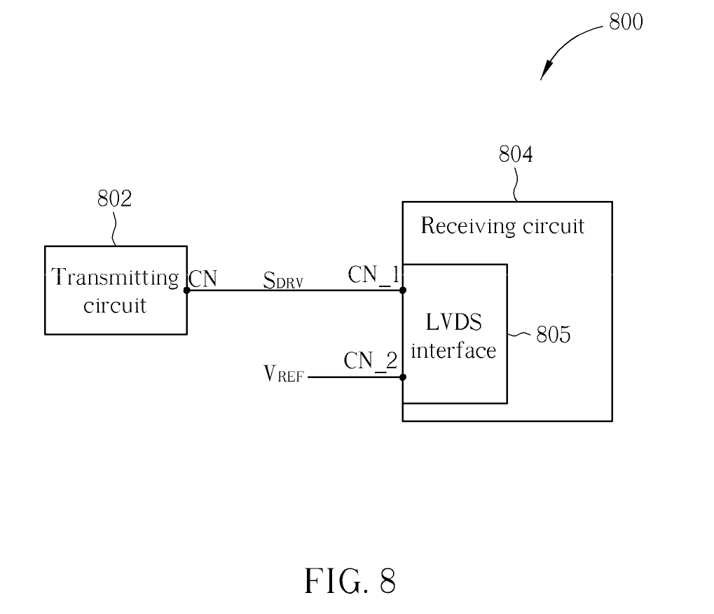

As mentioned above, the conception of the present invention is to share a signal transmission port (e.g., a chip's pin) between different signal processing operations. In an alternative design, the same signal transmission port (e.g., the same pin) is for connecting a reference voltage used by different signal processing operations. In this way, the same objective of reducing the pin count of a chip can be achieved. Please refer to FIG. 8, which is a diagram illustrating a fifth exemplary embodiment of an electronic apparatus according to the present invention. The exemplary electronic apparatus 800 includes, but is not limited to, a transmitting circuit 802 and a receiving circuit 804. The transmitting circuit 802 has a connection node CN, wherein the transmitting circuit 802 generates a transmission signal S_{DRV} passing through the connection node CN. The receiving circuit 804 has a low-voltage differential signaling (LVDS) interface 805 with a first connection node CN_1 and a second connection node CN_2, wherein the first connection node CN_1 is coupled to the connection node CN of the transmitting circuit 802, and the second connection node CN_2 is coupled to a reference voltage V_{REF} having a constant voltage level. In general, the LVDS technique is commonly used for high-speed data transmission and requires two transmission lines for differential transmission. In other words, when the LVDS is employed in a chip, two pins of the chip are assigned to the LVDS due to differential transmission. However, regarding low-speed data transmission, the present invention proposes using a single-ended transmission in place of the conventional differential transmission when a receiving end uses an LVDS interface for signal reception. Thus, one of the transmission lines is used for transmitting a reference voltage with a constant voltage level, whereas the other of the transmission lines is used for transmitting a single-ended signal (e.g., the transmission signal S_{DRV}). As a reference voltage pin of the chip is shared between an external LVDS receiver (which is disposed outside of the chip) and other circuitry (which is disposed within the chip), the pin count of the chip can be reduced accordingly.

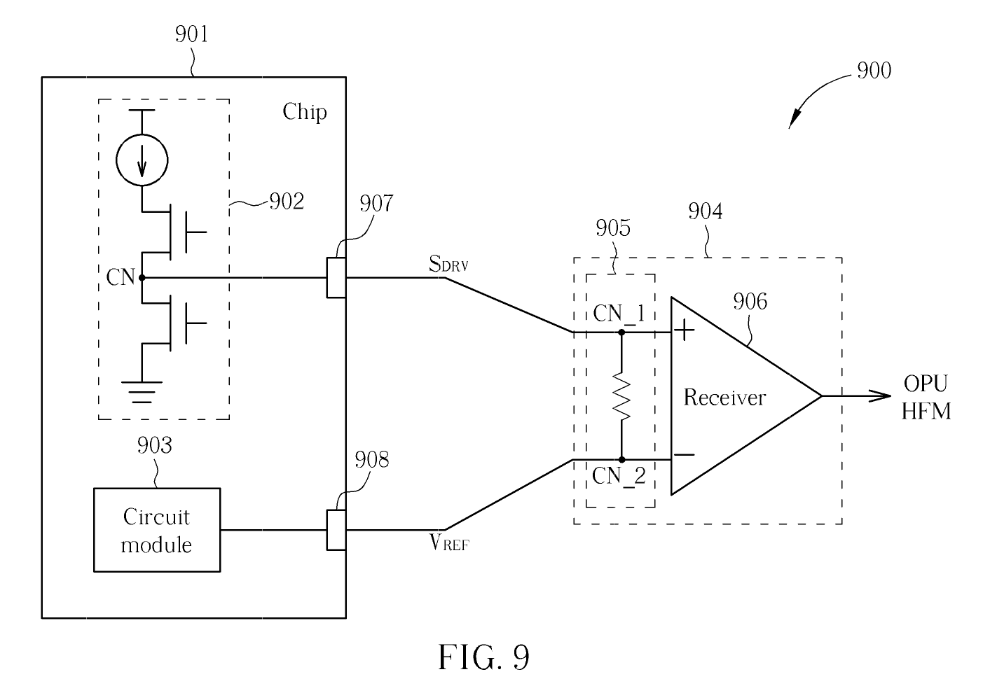

Please refer to FIG. 9, which is a diagram illustrating one exemplary electronic apparatus employing the hardware configuration shown in FIG. 8. The electronic apparatus 900 includes, but is not limited to, a chip 901 and a receiving circuit 904. The chip 901 includes a transmitting circuit 902, a circuit module 903, a first pin 907, and a second pin 908. The receiving circuit 904 includes an LVDS interface 905 and a receiver 906, wherein the receiver 906 may be simply implemented using an operational amplifier. The first pin 907 is coupled to the connection node CN of the transmitting circuit 902 and the first connection node CN_1 of the receiving circuit 904, and the second pin 908 is coupled to the circuit module 903 and the second connection node CN_2 of the receiving circuit 904.

As can be seen from FIG. 9, a reference voltage V_{REF} required by the circuit module 903 inside the chip 901 is received via the second pin 908; in addition, the reference voltage V_{REF} used by the circuit module 903 is also supplied to the second connection node CN_2 which is electrically connected to the second pin 908. As shown in FIG. 9, the first connection node CN_1 of the LVDS interface 905 is coupled to the non-inverting input (+) of the receiver 906, and the second connection node CN_2 is coupled to an inverting input (−) of the receiver 906. Therefore, due to the inherent characteristic of the LVDS receiver architecture, the receiver 906 receives data bits according to the difference between the transmission signal S_{DRV} and the reference voltage V_{REF} (i.e., S_{DRV}-V_{REF}). By way of example, but not limitation, the single-ended transmission signal S_{DRV} controlled by the transmitting circuit 902 may be used to control an on/off status of a high frequency modulation (HFM) of an optical pick-up unit (OPU) since the OPU HFM control does not require a high-speed signal transmission.

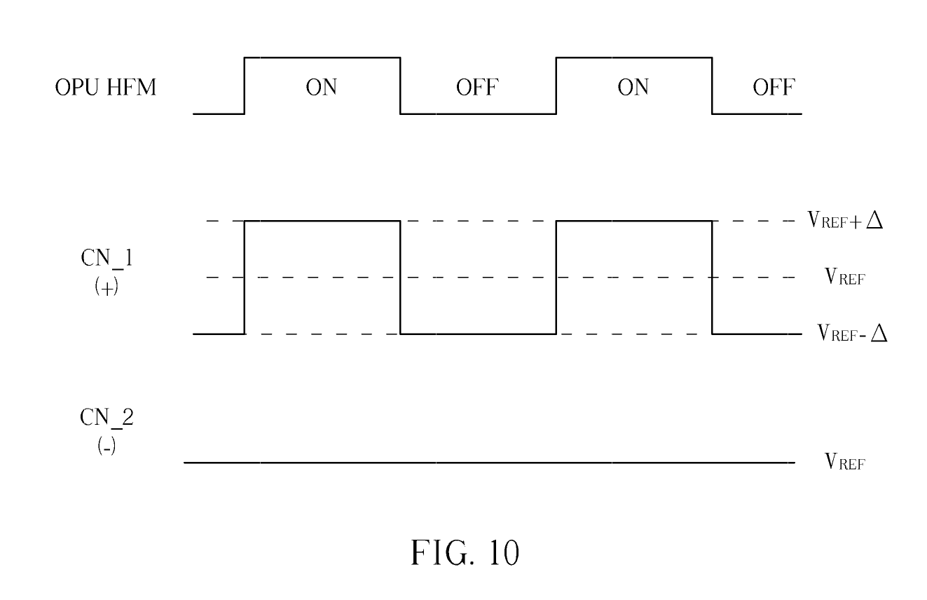

Please refer to FIG. 9 in conjunction with FIG. 10. FIG. 10 is a diagram illustrating the operation of the electronic apparatus 900 shown in FIG. 9. As can be seen from FIG. 10, the transmitting circuit 902 is controlled to set the voltage level of the transmission signal S_{DRV} to V_{REF}+Δ for turning on the OPU HFM, and is controlled to set the voltage level of the transmission signal S_{DRV} to V_{REF}−Δ for turning off the OPU HFM, wherein the offset voltage Δ may be 350 mV. An objective of generating a single-ended transmission signal S_{DRV} for controlling the OPU HFM is achieved.

Consider a case where a conventional chip employs an internal LVDS transmitter for communicating with an external LVDS receiver. The implementation of an LVDS interface at the chip side would require two dedicated pins for differential signal transmission. Besides, the conventional chip further requires a reference voltage pin for receiving a reference voltage (e.g., a supply voltage). However, regarding the exemplary chip 901 of the present invention, the transmitting circuit 902 within the chip 901 is configured to transmit a single-ended signal to one connection node CN_1 of the LVDS interface 905 of the receiving circuit 904. Thus, the implementation of a single-ended interface at the chip side only requires one dedicated pin (e.g., the first pin 907) for single-ended signal transmission. Moreover, a reference voltage pin (e.g., the second pin 908) originally equipped in the chip 901 is further electrically connected to another connection node CN_2 of the LVDS interface 905. In this way, the LVDS interface 905 of the receiving circuit 904 can work normally though the transmitting circuit 902 generates a single-ended signal. Briefly summarized, regarding the conventional chip design, an LVDS interface at the receiving circuit would have two connection nodes respectively connected to two dedicated pins of the conventional chip, and a reference voltage source would be connected to a reference voltage pin of the conventional chip. However, regarding the exemplary chip design of the present invention, the LVDS interface 905 at the receiving circuit 904 would have two connection nodes CN_1 and CN_2 respectively connected to one dedicated pin (e.g., the first pin 907) and one shared reference voltage pin (e.g., the second pin 908) of the chip 901, and a reference voltage source (nor shown) would also be connected to the shared reference voltage pin (e.g., the second pin 908). Therefore, due to the use of the shared reference voltage pin, the pin count of the chip 901 is reduced accordingly.

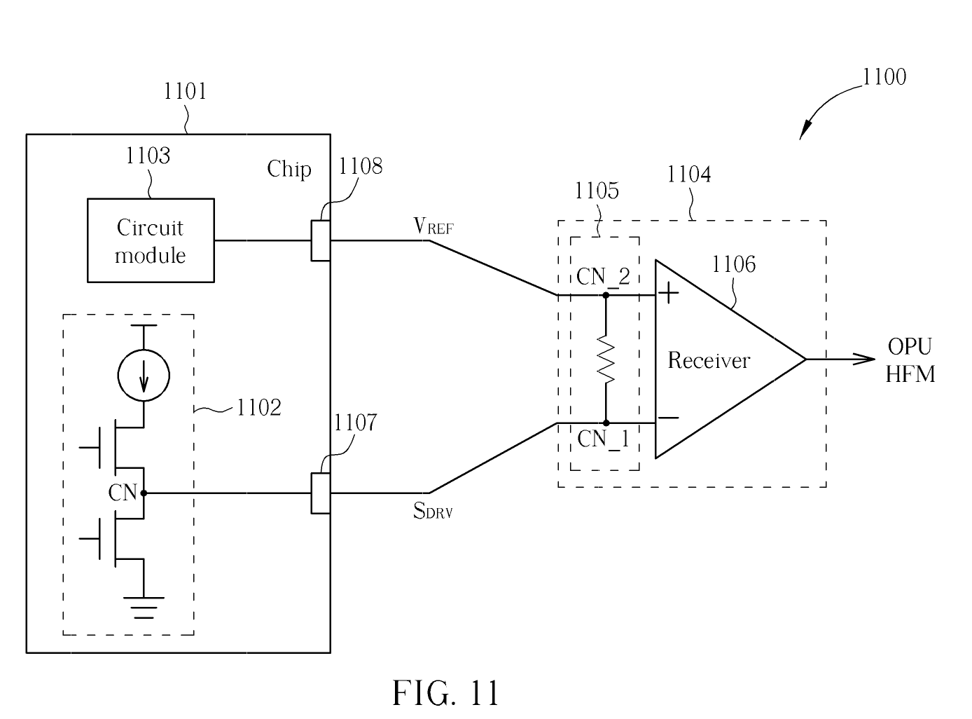

FIG. 11 is a diagram illustrating another exemplary electronic apparatus employing the hardware configuration shown in FIG. 8. The electronic apparatus 1100 includes, but is not limited to, a chip 1101 and a receiving circuit 1104. The chip 1101 includes a transmitting circuit 1102, a circuit module 1103, a first pin 1107, and a second pin 1108. The receiving circuit 1104 includes an LVDS interface 1105 and a receiver (e.g., an operational amplifier) 1106. The major difference between the electronic apparatuses 900 and 1100 is that the first connection node CN_1 of the LVDS interface 1105 is coupled to the inverting input (−) of the receiver 1106, and the second connection node CN_2 of the LVDS interface 1105 is coupled to a non-inverting input (+) of the receiver 1106. In other words, the reference voltage V_{REF} with a constant voltage level is supplied to the non-inverting input (+) of the receiver 1106, and the single-ended transmission signal S_{DRV} is presented at the inverting input (−) of the receiver 1106. Therefore, due to the inherent characteristic of the LVDS receiver architecture, the receiver 1106 receives data bits according to the difference between the reference voltage V_{REF} and the transmission signal S_{DRV} (i.e., V_{REF}−S_{DRV}).

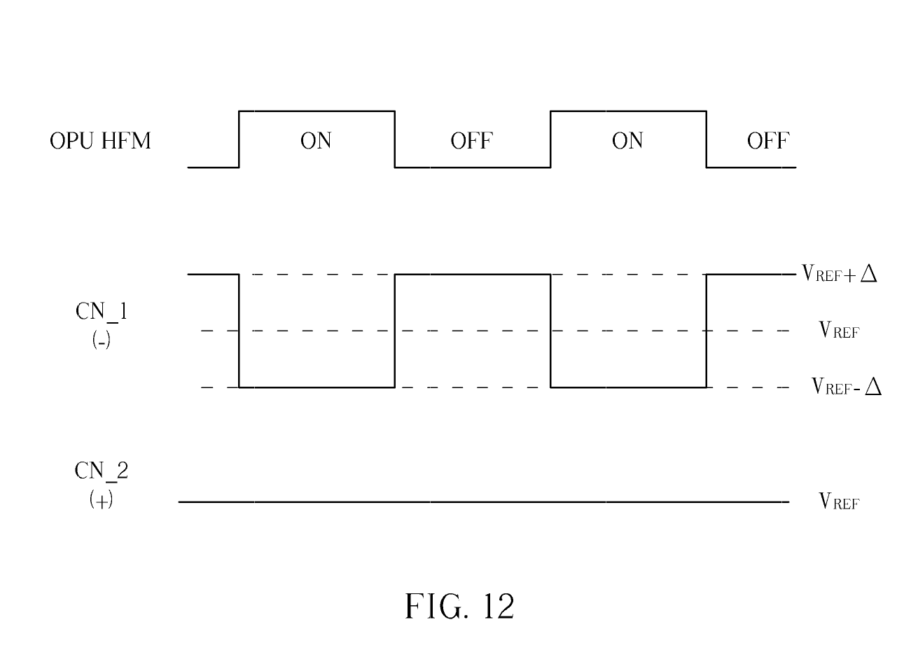

Please refer to FIG. 11 in conjunction with FIG. 12. FIG. 12 is a diagram illustrating the operation of the electronic apparatus 1100 shown in FIG. 11. As can be seen from FIG. 12, the transmitting circuit 1101 is controlled to set the voltage level of the transmission signal S_{DRV} to V_{REF}−Δ for turning on the OPU HFM, and is controlled to set the voltage level of the transmission signal S_{DRV} to V_{REF}+Δ for turning off the OPU HFM. The same objective of generating a single-ended transmission signal S_{DRV} for controlling the OPU HFM is achieved.

As mentioned above, a conventional chip, employing an internal LVDS transmitter for communicating with an external LVDS receiver, would require two dedicated pins for differential signal transmission; additionally, the conventional chip further requires a reference voltage pin for receiving a reference voltage (e.g., a supply voltage). However, regarding the exemplary chip 1101 of the present invention, the transmitting circuit 1102 within the chip 1101 is configured to transmit a single-ended signal to one connection node CN_1 of the LVDS interface 1105 of the receiving circuit 1104. Thus, the implementation of a single-ended interface at the chip side only requires one dedicated pin (e.g., the first pin 1107) for single-ended signal transmission. Moreover, a reference voltage pin (e.g., the second pin 1108) originally equipped in the chip 1101 is further electrically connected to another connection node CN_2 of the LVDS interface 1105. In this way, the LVDS interface 1105 of the receiving circuit 1104 can work normally though the transmitting circuit 1102 generates a single-ended signal. Briefly summarized, regarding the conventional chip design, an LVDS interface at the receiving circuit would have two connection nodes respectively connected to two dedicated pins of the conventional chip, and a reference voltage source would be connected to a reference voltage pin of the conventional chip. However, regarding the exemplary chip design of the present invention, the LVDS interface 1105 at the receiving circuit 1104 would have two connection nodes CN_1 and CN_2 respectively connected to one dedicated pin (e.g., the first pin 1107) and one shared reference voltage pin (e.g., the second pin 1108) of the chip 1101, and a reference voltage source (nor shown) would also be connected to the shared reference voltage pin (e.g., the second pin 1108). Therefore, due to the use of the shared reference voltage pin, the pin count of the chip 1101 is reduced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal processing apparatus, comprising:
a signal transmission port, shared between different signal processing operations for signal transmission, wherein the different signal processing operations include a first signal processing operation and a second signal processing operation;
a first signal processing circuit, arranged to performing the first signal processing operation, wherein when the signal processing apparatus operates, the first signal processing circuit is not required to be consistently enabled to use the signal transmission port for signal transmission;
a second signal processing circuit, arranged to perform the second signal processing operation, wherein the signal transmission port is not always required to carry out signal transmission each time the second signal processing circuit is enabled to perform the second signal processing operation; and
a control circuit, arranged to control the first signal processing circuit and the second signal processing circuit, wherein the control circuit selectively enables the first signal processing circuit to perform the first signal processing operation or enables the second signal processing circuit to perform the second signal processing operation.

2. The signal processing apparatus of claim 1, wherein when the control circuit receives a request for the first signal processing operation, the control circuit alternately enables the first signal processing circuit and the second signal processing circuit during a first time period.

3. The signal processing apparatus of claim 2, wherein when the control circuit does not receive the request for the first signal processing operation, the control circuit enables the second signal processing circuit and does not enable the first signal processing circuit during a second time period.

4. The signal processing apparatus of claim 1, wherein the first signal processing operation performed by the first signal processing circuit is for outputting an output signal via the signal transmission port.

5. The signal processing apparatus of claim 4, wherein the first signal processing circuit is a driving circuit which performs the first signal processing operation to generate the output signal utilized to drive a light emitting device.

6. The signal processing apparatus of claim 1, wherein the second signal processing operation performed by the second signal processing circuit is for detecting an occurrence of an input signal received at the signal transmission port.

7. The signal processing apparatus of claim 6, wherein the second signal processing circuit is a detecting circuit which performs the second signal processing operation to monitor a switch status change of a switch device by detecting the occurrence of the input signal generated due to the switch status change of the switch device.

8. The signal processing apparatus of claim 1, wherein the first signal processing circuit and the second signal processing circuit are both disposed in a chip, and the signal transmission port is a pin of the chip.

9. A signal processing method, comprising:
providing a signal transmission port shared between different signal processing operations for signal transmission, wherein the different signal processing operations include a first signal processing operation and a second signal processing operation; and
selectively enabling the first signal processing operation or the second signal processing operation, wherein when the signal processing method is executed, the first signal processing operation is not required to be consistently enabled to use the signal transmission port for signal transmission, and the signal transmission port is not always required to carry out signal transmission each time the second signal processing operation is enabled.

10. The signal processing method of claim 9, wherein selectively enabling the first signal processing operation or the second signal processing operation comprises:
when a request for the first signal processing operation is received, alternately enabling the first signal processing operation and the second signal processing operation during a first time period.

11. The signal processing method of claim 10, wherein selectively enabling the first signal processing operation or the second signal processing operation further comprises:
when the request for the first signal processing operation is not received, enabling the second signal processing operation and not enabling the first signal processing operation during a second time period.

12. The signal processing method of claim 9, wherein the first signal processing operation is for outputting an output signal via the signal transmission port.

13. The signal processing method of claim 12, wherein the first signal processing operation generates the output signal utilized to drive a light emitting device.

14. The signal processing method of claim 9, wherein the second signal processing operation is for detecting an occurrence of an input signal received at the signal transmission port.

15. The signal processing method of claim 14, wherein the second signal processing operation monitors a switch status change of a switch device by detecting the occurrence of the input signal generated due to the switch status change of the switch device.

16. The signal processing method of claim 9, wherein the first signal processing operation and the second signal processing operation are both performed by a chip, and the signal transmission port is a pin of a chip.

17. An electronic apparatus, comprising:
a first circuit element;
a second circuit element; and
a chip, comprising:
a pin, coupled to the first circuit element and the second circuit element, wherein the pin is shared between different signal processing operations for signal transmission, and the different signal processing operations include a first signal processing operation and a second signal processing operation;
a first signal processing circuit, arranged to perform the first signal processing operation and communicate with the first circuit element via the pin, wherein when the chip operates, the first signal processing circuit is not required to be consistently enabled to use the signal transmission port for signal transmission;
a second signal processing circuit, arranged to perform the second signal processing operation and communicate with the second circuit element via the pin, wherein the signal transmission port is not always required to carry out signal transmission each time the second signal processing circuit is enabled to perform the second signal processing operation; and
a control circuit, arranged to control the first signal processing circuit and the second signal processing circuit, wherein the control circuit selectively enables the first signal processing circuit to perform the first signal processing operation or enables the second signal processing circuit to perform the second signal processing operation.

18. The electronic device of claim 17, wherein the first circuit element receives an output signal of the chip, and the output signal is generated from the first signal processing circuit.

19. The electronic device of claim 18, wherein the first circuit element is a light emitting device which is driven by the output signal, and the first signal processing circuit is a driving circuit which performs the first signal processing operation to generate the output signal to the light emitting device.

20. The electronic device of claim 19, wherein the second circuit element is a switch device which generates an input signal of the chip when a switch status change of the switch device occurs, and the second signal processing circuit is a detecting circuit which performs the second signal processing operation to monitor the switch status change of the switch device by detecting the occurrence of the input signal; the light emitting device has a first node coupled to a first reference voltage and a second node coupled to the pin; the switch device has a first node coupled to the pin and a second node coupled to a second reference voltage; and when the second signal processing circuit is initially enabled, the second signal processing circuit sets a voltage level of the pin to a constant voltage level for detecting the occurrence of the input signal and turning off the light emitting device.

21. The electronic device of claim 17, wherein the second circuit element is for generating an input signal of the chip to be detected by the second signal processing circuit.

22. The electronic device of claim 21, wherein the second circuit element is a switch device which generates the input signal when a switch status change of the switch device occurs, and the second signal processing circuit is a detecting circuit which performs the second signal processing operation to monitor the switch status change of the switch device by detecting the occurrence of the input signal.

23. An electronic device, comprising:
a transmitting circuit, having a connection node, wherein the transmitting circuit generates a transmission signal passing through the connection node; and
a receiving circuit, having a low-voltage differential signaling (LVDS) interface with a first connection node and a second connection node, wherein the first connection node is coupled to the connection node of the transmitting circuit, and the second connection node is coupled to a reference voltage.

24. The electronic device of claim 23, wherein the transmitting circuit is disposed in a chip which further has a circuit module included therein; the chip has a first pin and a second pin; the first pin is coupled to the connection node of the transmitting circuit and the first connection node of the receiving circuit; and the second pin is coupled to the circuit module and the second connection node of the receiving circuit.

25. The electronic device of claim 23, wherein the transmission signal controls an on/off status of a high frequency modulation (HFM) of an optical pick-up unit (OPU).
